(19) United States
(12) Patent Application Publication
(10) Pub. No.: US 2026/0176189 A1
(43) Pub. Date: Jun. 25, 2026

(54) CONDUCTIVE ALUMINUM PASTE COMPOSITION FOR TOPCON-TYPE SOLAR CELL ELECTRODE AND TOPCON-TYPE SOLAR CELL LAYERED WITH REVERSE SURFACE ELECTRODE BEING FIRED BODY OF COMPOSITION

(71) Applicant: TOYO ALUMINIUM KABUSHIKI KAISHA, Osaka-shi, Osaka (JP)

(72) Inventors: Kosuke Tsuji, Osaka-shi (JP); Shota Suzuki, Osaka-shi (JP); Takashi Kuroki, Osaka-shi (JP)

(73) Assignee: TOYO ALUMINIUM KABUSHIKI KAISHA, Osaka-shi, Osaka (JP)

(21) Appl. No.: 18/849,070

(22) PCT Filed: Mar. 23, 2023
(86) PCT No.: PCT/JP2023/011647

§ 371 Date: Sep. 20, 2024

(30) Foreign Application Priority Data
Mar. 28, 2022 (JP) 2022-052385

(51) Int. Cl. C03C 8/02; C03C 8/22

(52) U.S. Cl. CPC C03C 8/02; C03C 8/22

(57) ABSTRACT

A conductive aluminum paste composition is disclosed, including an aluminum-silicon alloy powder, an organic vehicle, and a glass powder, in which (1) the aluminum-silicon alloy powder has a silicon concentration of 30 mass % or more and 40 mass % or less, and (2) the glass powder contains a first glass powder and a second glass powder. The first glass powder contains 45% or more and 71% or less of PbO, 5% or more and 35% or less of B₂O₃, and 0.1% or more and 25.0% or less of SiO₂ in terms of oxide mol %, and the second glass powder contains 35.0% or more and 55.0% or less of B₂O₃, 5.0% or more and 10.0% or less of SiO₂, 1.0% or more and 20.0% or less of BaO, 5.0% or more and 25.0% or less of CaO, and 3.0% or more and 30.0% or less of K₂O in terms of oxide mol %.

### TECHNICAL FIELD

The present invention relates to a conductive aluminum paste composition for TOPCon Si solar cell (TOPCon-type solar cell) electrodes and TOPCon Si solar cell layered with back-side electrodes being sintered body of composition.

### BACKGROUND ART

Conventionally, as one of techniques for improving efficiency, reliability, and the like of a solar cell, a solar cell element employing a TOPCon (Tunnel Oxide Passivated Contact) structure has been devised. Hereinafter, in the present specification, a solar cell adopting this structure is referred to as a “TOPCon Si solar cell”.

In the TOPCon structure, in order to reduce recombination loss between an n-type silicon substrate serving as a base substrate and back-side electrodes using silver, aluminum, or the like, a thin tunnel oxide layer made of silicon oxide and having a thickness of about several mm, a semiconductor layer (microcrystalline n⁺ silicon layer) doped with high-concentration phosphorus, boron, or the like, and a passivation film made of Si₃N₄, Al₂O₃, or the like are formed between the base substrate and back-side electrodes. This structure is characterized in that a tunneling effect is generated by the oxide layer to suppress carrier loss at an interface between the n-type silicon substrate and the microcrystalline n′ silicon layer.

When back-side electrodes are formed using a silver paste in a TOPCon Si solar cell, back-side electrodes can be formed by applying the silver paste to a passivation film and then subjecting the silver paste to a heat treatment to partially penetrate the passivation film by fire-through. On the other hand, when back-side electrodes are formed using an aluminum paste, a passivation film cannot be fire-through, and therefore an opening (laser contact opening (LCO)) in which an n-type silicon substrate is exposed is formed in advance by laser treatment or the like at a contact part with the n-type silicon substrate, and an aluminum paste is applied so as to overlap the opening, and then heat treatment is performed to form back-side electrodes (PTL 1). In PIL 1, the use of a conductive aluminum paste composition containing aluminum-silicon alloy particles, an organic vehicle, and glass powder has studied.

Other than the TOPCon Si solar cell, as an aluminum paste having a fire-through property capable of forming back-side electrodes without forming LCO, a back-side electrodes paste containing an aluminum powder, a lead glass powder, and an organic vehicle for a p-type silicon substrate is known (PTL 2), and as a lead-free aspect, a back-side electrodes paste containing an aluminum powder, a lead-free glass powder, and an organic vehicle is known (PTL 3).

### CITATION LIST

### Patent Literatures

PTL 1: JP2021-2460A
PTL 2: JP2019-127404A
PTL 3: JP2020-198380A

### SUMMARY OF INVENTION

### Technical Problem

However, in the case of forming back-side electrodes using the aluminum paste in the TOPCon Si solar cell, it is necessary to form the LCO (opening) and apply (print) the aluminum paste so that the aluminum paste overlaps the LCO. Therefore, a high alignment technique is required, and it is difficult to meet the demand for cost reduction in that it is necessary to form the LCO as compared with the case of using the silver paste. On the other hand, if only the aluminum paste as in PIL 1 is applied without forming the LCO, the passivation film cannot be fire-through (penetrated) when the coating film of the aluminum paste is fired as described above, and the microcrystalline n⁺ silicon layer cannot be reached, so that the conversion efficiency of the cell is greatly reduced.

In addition, when an aluminum paste for a p-type silicon substrate as in PTLs 2 and 3 is applied to a TOPCon Si solar cell, even if fire-through can be performed, an alloy layer (aluminum-silicon alloy layer) is generated by a reaction between an n-type silicon substrate and aluminum, so that the formed pt layer and the microcrystalline n⁺ silicon layer are shunted, and the conversion efficiency of the cell is also significantly reduced.

Therefore, an object of the present invention is to provide a conductive aluminum paste composition in which a paste itself has a fire-through property of a passivation film in formation of back-side electrodes of a TOPCon Si solar cell, there is no need to form LCO, and further, a good ohmic contact can be obtained without forming an alloy layer with an n-type silicon substrate. Another object of the present invention is to provide a TOPCon Si solar cell in which back-side electrodes as a sintered body is layered.

### Solution to Problem

As a result of intensive studies to achieve the above object, the present inventors have found that the above object can be achieved by using a conductive aluminum paste composition containing an aluminum-silicon alloy powder having a specific composition and a glass powder, and have completed the present invention.

That is, the present invention relates to the following conductive aluminum paste composition for TOPCon Si solar cell electrodes and TOPCon Si solar cell using the same.

1. A conductive aluminum paste composition for TOPCon Si solar cell electrodes, the conductive aluminum paste composition including an aluminum-silicon alloy powder, an organic vehicle, and a glass powder,
in which
(1) the aluminum-silicon alloy powder has a silicon concentration of 30 masse or more and 40 mass % or less, and
(2) the glass powder contains a first glass powder and a second glass powder, and
the first glass powder contains 45% or more and 71% or less of PbO, 5% or more and 35% or less of B₂O₃, and 0.1% or more and 25.0% or less of SiO₂ in terms of oxide mol %, and a value of [(x+y)/z] is in a range of 0.40 or more and 1.00 or less where the content of B₂O₃ is x mol %, the content of SiO₂ is y mol %, and the content of PbO is z mol %, and
the second glass powder contains 35.0% or more and 55.0% or less of B₂O₃, 5.0% or more and 10.0% or less of SiO₂, 1.0% or more and 20.0% or less of BaO, 5.0% or more and 25.0% or less of CaO, and 3.0% or more and 30.0% or less of K₂O in terms of oxide mol %, and does not substantially contain PbO.
2. The conductive aluminum paste composition according to item 1, in which the first glass powder contains Al₂O₃ and/or ZnO in a total amount of 1% or more and 10% or less in terms of oxide mol %.
3. The conductive aluminum paste composition according to item 1 or 2, in which the second glass powder contains 1.0% or more and 10.0% or less of SrO in terms of oxide mol %.
4. A TOPCon Si solar cell, in which back-side electrodes which are sintered body of the conductive aluminum paste composition according to any one of items 1 to 3 is layered on a silicon semiconductor substrate.

### Advantageous Effects of Invention

Since the conductive aluminum paste composition of the present invention contains an aluminum-silicon alloy powder having a specific composition and a glass powder, the paste itself has a fire-through property of a passivation film in formation of back-side electrodes of a TOPCon Si solar cell, and it is not necessary to form LCO, and further, a good ohmic contact can be obtained without forming an alloy layer with an n-type silicon substrate. Note that not forming an alloy layer with the n-type silicon substrate means that there is no erosion in the microcrystalline n⁺ silicon layer, and obtaining a good ohmic contact means that the contact resistance is 10 mΩ·cm² or less as an index of high conversion efficiency.

### BRIEF DESCRIPTION OF DRAWINGS

FIG. 1 is a schematic cross-sectional view showing an example of a structure of a TOPCon Si solar cell.

FIG. 2 is a view showing a print width when a conductive aluminum paste composition is screen-printed on a surface of a microcrystalline n⁺ silicon layer in Examples and Comparative examples. Specifically, it indicates that setting was performed so as to be parallel under the conditions of a print width of 1 mm, a length of 10 mm, and print intervals of 1.2 mm, 1.4 mm, 1.6 mm, 1.8 mm, and 2.0 mm.

### DESCRIPTION OF EMBODIMENTS

Hereinafter, the conductive aluminum paste composition for TOPCon Si solar cell electrodes of the present invention and a TOPCon Si solar cell using the same will be described in detail. In the present specification, the numerical range indicated by “to” indicates “greater than or equal to and less than or equal to” unless otherwise specified. That is, “A to B” indicates a range of A or more and B or less.

### 1. TOPCon Si Solar Cell

The conductive aluminum paste composition of the present invention is for TOPCon Si solar cell electrodes, but as long as the conductive aluminum paste composition contains an aluminum-silicon alloy powder, an organic vehicle, and a glass powder, and particularly the aluminum-silicon alloy powder and the glass powder have a predetermined specific composition, the other requirements can apply to the requirements of the known TOPCon Si solar cell.

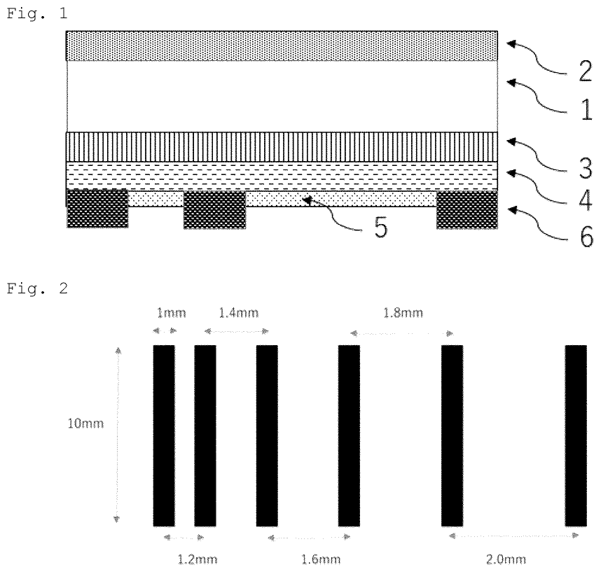

FIG. 1 is a schematic cross-sectional view showing an example of a structure of a TOPCon Si solar cell. A TOPCon Si solar cell shown in FIG. 1 has a p-type impurity layer 2 formed on a light-receiving surface side of an n-type silicon semiconductor substrate 1 of a base substrate, includes back-side electrodes 6 on a back surface side of the n-type silicon semiconductor substrate 1, and includes an extremely thin oxide layer 3 and a microcrystalline n⁺ silicon layer 4 highly doped with a dopant between the n-type silicon semiconductor substrate 1 and back-side electrodes 6. Specifically, between the n-type silicon semiconductor substrate 1 and back-side electrodes 6, the oxide layer 3 is provided on the n-type silicon semiconductor substrate 1 side, and the microcrystalline n⁺ silicon layer 4 is provided on back-side electrodes 6 side. By having this structure, in the TOPCon Si solar cell, the tunnel effect is generated by the oxide layer 3, and carrier loss at the interface between the n-type silicon semiconductor substrate 1 (n⁻ silicon layer) and the microcrystalline n⁺ silicon layer 4 (n⁺ silicon layer) can be suppressed.

As the oxide layer 3, for example, silicon oxide is applied. The thickness of the oxide layer 3 is not limited, and may be, for example, 1 to 10 nm, and is preferably 3 to 8 nm. When the thickness of the oxide layer 3 is 1 to 10 nm, the above-described tunnel effect easily occurs, and carriers easily move to the back surface side of the solar cell, resulting in an increase in conversion efficiency. In addition, when the thickness of the oxide layer 3 is 1 to 10 nm, carrier loss at the interface between the n-silicon layer and the n⁺ silicon layer is also easily suppressed, so that the conversion efficiency is hardly reduced.

As the n-type silicon semiconductor substrate 1, for example, a silicon semiconductor substrate used for semiconductor applications or solar cell applications can be widely applied.

In the TOPCon Si solar cell of the present invention, a passivation film 5 is provided between the microcrystalline n⁺ silicon layer 4 and back-side electrodes 6. Since the conductive aluminum paste composition of the present invention has the fire-through property of the passivation film 5, it is not necessary to form LCO (opening) in the passivation film 5 in formation of back-side electrodes 6. Finger electrodes (not illustrated in FIG. 1) are formed on a surface of the n-type silicon semiconductor substrate 1 opposite to back-side electrodes 6 with a p-type impurity layer interposed therebetween. Finger electrodes are formed of, for example, silver, aluminum, or the like.

Back-side electrodes 6 are formed of the conductive aluminum paste composition of the present invention. Although details will be described later, when the conductive aluminum paste composition of the present invention contains an aluminum-silicon alloy powder having a specific composition and a glass powder, the paste itself has the fire-through property of the passivation film 5 in formation of back-side electrodes 6 of the TOPCon Si solar cell, and it is not necessary to form LCO, and further, a good ohmic contact can be obtained without forming an alloy layer with the n-type silicon semiconductor substrate 1. In addition, the conductive aluminum paste composition can easily form a pre-firing coating film of back-side electrodes 6 in that a known printing method such as a screen printing method can be adopted.

### 2. Conductive Aluminum Paste Composition

The conductive aluminum paste composition of the present invention is for TOPCon Si solar cell electrodes, and is specifically used for formation of back-side electrodes. The paste composition contains an aluminum-silicon alloy powder, an organic vehicle, and a glass powder,
in which
(1) the aluminum-silicon alloy powder has a silicon concentration of 30 mass % or more and 40 mass % or less, and
(2) the glass powder contains a first glass powder and a second glass powder, and
the first glass powder contains 45% or more and 71% or less of PbO, 5% or more and 35% or less of B₂O₃, and 0.1% or more and 25.0% or less of SiO₂ in terms of oxide mol %, and a value of [(x+y)/z] is in a range of 0.40 or more and 1.00 or less where the content of B₂O₃ is x mol %, the content of SiO₂ is y mol %, and the content of PbO is z mol %, and
the second glass powder contains 35.0% or more and 55.0% or less of B₂O₃, 5.0% or more and 10.0% or less of SiO₂, 1.0% or more and 20.0% or less of BaO, 5.0% or more and 25.0% or less of CaO, and 3.0% or more and 30.0% or less of K₂O in terms of oxide mol %, and does not substantially contain PbO.

According to the conductive aluminum paste composition of the present invention having the above characteristics, in formation of back-side electrodes of a TOPCon Si solar cell, the paste itself has a fire-through property of a passivation film, and there is no need to form LCO, and further, a good ohmic contact can be obtained without forming an alloy layer with an n-type silicon substrate. Note that not forming an alloy layer with the n-type silicon substrate means that there is no erosion in the microcrystalline n⁺ silicon layer, and obtaining a good ohmic contact means that the contact resistance is 10 mΩ·cm² or less as an index of high conversion efficiency.

Hereinafter, each component of the conductive aluminum paste composition of the present invention will be described in detail.

### Aluminum-Silicon Alloy Powder

In the conductive aluminum paste composition, the aluminum-silicon alloy powder is a component that can play a role of providing conductivity. In the conductive aluminum paste composition of the present invention, an aluminum-silicon alloy powder having a silicon concentration of 30 mass % or more and 40 mass % or less (preferably 35 mass % or more and 40 mass % or less) is used. In the present invention, by using the aluminum-silicon alloy powder as the conductive component, migration of the electrodes material does not occur as compared with silver, and the possibility of short circuit is reduced.

When the silicon concentration is 30 masse or more and 40 mass % or less, the conductive aluminum paste composition is less likely to melt with the microcrystalline n⁺ silicon layer in the firing step, whereby the conductive aluminum paste composition and the microcrystalline n⁺ silicon layer are less likely to form an aluminum-silicon alloy layer. As a result, a decrease in conversion efficiency of the cell due to carrier loss is suppressed. When the silicon concentration is less than 30 mass %, since a p⁺ layer is formed, there is a possibility that conversion efficiency is reduced. If the silicon concentration exceeds 40 mass %, the resistance may increase and it may be difficult to produce an aluminum-silicon alloy powder. Therefore, in the present invention, silicon having a silicon concentration of 30 mass % or more and 40 mass % or less is used.

The size of the particles of the aluminum-silicon alloy powder is not particularly limited. For example, the volume average particle diameter D50 of the aluminum-silicon alloy powder (particles) can be 1 to 10 μm. Among them, the volume average particle diameter D50 is preferably 5 to 8 μm. The volume average particle diameter D50 of the aluminum-silicon alloy powder in the present specification is a value measured by a laser diffraction method.

The aluminum-silicon alloy powder may contain strontium as the third component. That is, as the conductive powder containing strontium, in addition to the aluminum-silicon-strontium (Al—Si—Sr) alloy powder, an aluminum-silicon alloy powder and an aluminum-silicon-strontium alloy powder may be used in combination.

The amount of strontium contained in the conductive powder containing strontium is not particularly limited, but can be 0.01 to 1 mass %. By adding strontium to the conductive powder, there is an effect that when the silicon concentration is high, the composition amount of the liquid phase during firing increases, sintering is promoted, and the surface resistance decreases.

### Organic Vehicle

In the conductive aluminum paste composition of the present invention, the type of the organic vehicle is not particularly limited, and for example, a known organic vehicle used for forming back-side electrodes of a solar cell can be widely applied. Examples of the organic vehicle include a material in which a resin is dissolved in a solvent. Alternatively, the organic vehicle does not contain a solvent, and a resin itself may be used.

The kind of the solvent is not limited, and examples thereof include diethylene glycol monobutyl ether, diethylene glycol monobutyl ether acetate, and dipropylene glycol monomethyl ether. The organic vehicle may contain one kind or two or more kinds of solvents.

Examples of the resin include various known resins, and specific examples thereof include an ethyl cellulose resin, a nitrocellulose resin, a polyvinylbutyral resin, a phenol resin, a melamine resin, a urea resin, a xylene resin, an alkyd resin, an unsaturated polyester resin, an acrylic resin, a polyimide resin, a furan resin, a urethane resin, an isocyanate compound, a cyanate compound, a polyethylene resin, a polypropylene resin, a polystyrene resin, an ABS resin, a polymethyl methacrylate resin, a polyvinyl chloride resin, a polyvinylidene chloride resin, a polyvinyl acetate resin, a polyvinyl alcohol resin, a polyacetal resin, a polycarbonate resin, a polyethylene terephthalate resin, a polybutylene terephthalate resin, a polyphenylene oxide resin, a polysulfone resin, a polyimide resin, a polyether sulfone resin, a polyarylate resin, a polyether ether ketone resin, a polytetrafluoroethylene resin, and a silicon resin. The resin contained in the organic vehicle may be one kind or two or more kinds.

The organic vehicle can also contain various additives as necessary. Examples of the additive include an antioxidant, a corrosion inhibitor, an antifoaming agent, a thickener, a dispersant, a tackifier, a coupling agent, an electrostatic imparting agent, a polymerization inhibitor, a thixotropic agent, and an anti-settling agent. Specific examples thereof include a polyethylene glycol ester compound, a polyethylene glycol ether compound, a polyoxyethylene sorbitan ester compound, a sorbitan alkyl ester compound, an aliphatic polyvalent carboxylic acid compound, a phosphoric acid ester compound, an amide amine salt of a polyester acid, an oxidized polyethylene-based compound, a fatty acid amide wax, and an alkaline earth metal salt of stearic acid.

The rate of the resin, the solvent, and various additives contained in the organic vehicle can be arbitrarily adjusted, and for example, the component ratio can be the same as that of a known organic vehicle.

The content of the organic vehicle is not particularly limited, but is, for example, preferably 10 parts by mass or more and 500 parts by mass or less, and more preferably 20 parts by mass or more and 45 parts by mass or less with respect to 100 parts by mass of the aluminum-silicon alloy powder from the viewpoint of having good coating properties (printing properties).

### Glass Powder

The glass powder contained in the conductive aluminum paste composition of the present invention is a glassy frit (powder). In particular, in the present invention, a first glass powder (lead-containing glass) and a second glass powder (borosilicate glass substantially containing no lead) are contained as glass powders, and
the present invention is characterized by employing the glass powder having the following specific compositions:
the first glass powder contains 45% or more and 71% or less of PbO, 5% or more and 35% or less of B₂O₃, and 0.1% or more and 25.0% or less of SiO₂ in terms of oxide mol %, and a value of [(x+y)/z] is in a range of 0.40 or more and 1.00 or less where the content of B₂O₃ is x mol %, the content of SiO₂ is y mol %, and the content of PLO is z mole; and
the second glass powder contains 35.0% or more and 55.0% or less of B₂O₃, 5.0% or more and 10.0% or less of SiO₂, 1.0% or more and 20.0% or less of BaO, 5.0% or more and 25.0% or less of CaO, and 3.0% or more and 30.0% or less of K₂O in terms of oxide mol %, and does not substantially contain PbO.

In the present invention, by combining two types of the first glass powder and the second glass powder, the fire-through property of the passivation film is excellent, and a good ohmic contact can be obtained without forming an n-type silicon semiconductor substrate and an alloy layer (aluminum-silicon alloy layer) (that is, erosion into the microcrystalline n′ silicon layer in the firing process is suppressed). As a result, the conversion efficiency of the solar cell can be enhanced.

The first glass powder is lead-containing glass, and contains PbO by 45% or more and 71% or less, B₂O₃ by 5% or more and 35% or less, and SiO₂ by 0.1% or more and 25.0% or less in terms of oxide mol %, and a value of [(x+y)/z] is in a range of 0.40 or more and 1.00 or less where the content of B₂O₃ is x mol %, the content of SiO₂ is y mol %, and the content of PLO is z mol %.

In the first glass powder, the content of PbO can be set to 50% or more and 71% or less, and can be set to 60% or more and 718 or more. The content of B₂O₃ can be set to 10% or more and 32% or less, and can be set to 20% or more and 32% or less. The content of SiO₂ can be set to 1.0% or more and 23.0% or less, and can be set to 8.0% or more and 23.0% or less. Further, the value of [(x+y)/z] can be set to 0.40 or more and 0.90 or less, and can be set to 0.43 or more and 0.86 or less.

The first glass powder may contain Al₂O₃ and/or ZnO in a total amount of 1% or more and 10% or less in terms of oxide mol %. By containing these components, the weather resistance of the first glass powder can be improved, and the paste viscosity can be stabilized. The content of Al₂O₃ can be set to, for example, 18 or more and 7% or less. In addition, the content of ZnO can be set to, for example, 2% or more and 5% or less, and can be set to 3% or more and 4% or less.

The second glass powder is borosilicate glass substantially containing no lead, contains 35.0% or more and 55.0% or less of B₂O₃, 5.0% or more and 10.0% or less of SiO₂, 1.0% or more and 20.0% or less of BaO, 5.0% or more and 25.0% or less of CaO, and 3.0% or more and 30.0% or less of K₂O in terms of oxide mol %, and does not substantially contain PbO.

In the second glass powder, the content of B₂O₃ can be set to 40.0% or more and 53.0% or less, and can be set to 41.2% or more and 45.5% or less. The content of SiO₂ can be set to 6.58 or more and 9.0% or less, and can be set to 6.9% or more and 7.6% or less. The content of BaO can be set to 10.0% or more and 20.0% or less, and can be set to 15.1% or more and 18.4% or less. The content of CaO can be set to 6.0% or more and 20.0% or less, and can be set to 6.4% or more and 19.0% or less. In addition, the content of K₂O can be set to 10.0% or more and 30.0% or less, and can be set to 11.4% or more and 20.1% or less. The second glass powder does not substantially contain a lead component (PbO), which means that the content of the lead component is below the detection limit or can be equated with inevitable impurities by component analysis.

The second glass powder may contain 1.0% or more and 10.0% or less of SrO in terms of oxide mol %. The content of SrO can be set to 3.0% or more and 6.0% or less. By containing SrO, the weather resistance of the second glass powder can be improved, and the paste viscosity can be stabilized. In addition, the second glass powder may contain ZnO in an amount of 0.0% (including an aspect in which ZnO is substantially not contained) or more and 25.0% or less in terms of oxide mol %. The content of ZnO can be set to 1.0% or more and 25.0% or less, and can be set to 5.08 or more and 25.0% or less. When the second glass powder contains ZnO in the above range, the weather resistance of the glass can be increased to stabilize the paste viscosity.

The content of the glass powder is not particularly limited, but is, for example, preferably 0.5 parts by mass or more and 40 parts by mass or less, and more preferably 4 parts by mass or more and 15 parts by mass or less in total of the first glass powder and the second glass powder with respect to 100 parts by mass of the aluminum-silicon alloy powder from the viewpoint of balance between adhesion to the n-type silicon semiconductor substrate and electric resistance of back-side electrodes. The mixing ratio of the first glass powder and the second glass powder is preferably in the range of second glass powder:second glass powder (mass ratio)=1:3 to 3:1. Furthermore, the softening point of each glass powder is preferably 650° C. or lower, and the volume average particle diameter D50 of the glass particles constituting each glass powder is preferably 1 to 3 μm.

The conductive aluminum paste composition of the present invention is useful as the paste composition for back-side electrodes of a TOPCon Si solar cell described at the beginning. In addition to the invention of the conductive aluminum paste composition, the present invention also includes an invention of a TOPCon Si solar cell in which back-side electrodes which are sintered body of the conductive aluminum paste composition is layered.

The firing temperature at the time of firing the coating film of the conductive aluminum paste composition is not limited as long as desired back-side electrodes are formed, but the firing temperature is preferably 700° C. or higher. Thereby, formation of an alloy layer (aluminum-silicon alloy layer) by the conductive aluminum paste composition and the microcrystalline n⁺ silicon layer is suppressed, and desired back-side electrodes are easily formed. The upper limit of the firing temperature is preferably lower than the melting point of the aluminum-silicon alloy powder contained in the conductive aluminum paste composition, for example. In this case, it is difficult to form an alloy layer of the conductive aluminum paste composition and the microcrystalline n⁺ silicon layer further. From this point of view, the firing temperature is preferably 900° C. or lower, more preferably 850° C. or lower, and particularly preferably 800° C. or lower.

The firing time of the coating film can be appropriately determined according to the firing temperature. The time can be, for example, 1 minute or more and 300 minutes or less, and is preferably 1 minute or more and 5 minutes or less. The firing may be performed in either an air atmosphere or a nitrogen atmosphere. The firing method is also not particularly limited, and for example, the firing treatment can be performed using a known heating furnace.

### EXAMPLES

Hereinafter, the present invention will be specifically described with reference to Examples and Comparative examples. However, the present invention is not limited to Examples.

### Example 1

An aluminum-silicon alloy powder was produced by a gas atomization method. The aluminum-silicon alloy powder was produced so as to have a silicon concentration of 36 mass % and a volume average particle diameter D50 of 6.0 μm. A mixed glass powder was prepared by mixing a lead-containing glass powder (abbreviation P1) consisting of PbO: 50.00 mol %, SiO₂: 23.00 mol %, B₂O₃: 20.00 mol %, and Al₂O₃: 7.00 mol % as a first glass powder, and a borosilicate glass powder (abbreviation B1) consisting of B₂O₃: 45.50 mol %, SiO₂: 7.60 mol %, CaO: 19.00 mol %, BaO: 15.90 mol %, and K₂O: 12.00 mol % as a second glass powder at a mass ratio of 1:1. In addition, as an organic vehicle, a resin solution having a concentration of 10 mass % in which ethyl cellulose was dissolved in butyl diglycol was prepared.

Next, 100 parts by mass of the aluminum-silicon alloy particles and 5 parts by mass of the mixed glass powder were dispersed in 30 parts by mass of the organic vehicle using a disperser (disper) to obtain a conductive aluminum paste composition.

### Example 2

A conductive aluminum paste composition was obtained in the same manner as in Example 1 except that lead-containing glass powder (P2) consisting of PbO: 54.40 mol %, SiO₂: 12.80 mol %, B₂O₃: 23.50 mol %, Al₂O₃: 5.70 mol %, and ZnO: 3.60 mol % was used as the first glass powder.

### Example 3

A conductive aluminum paste composition was obtained in the same manner as in Example 1 except that a lead-containing glass powder (P3) consisting of PbO: 45.00 mol %, SiO₂: 15.00 mol %, B₂O₃: 30.00 mol %, Al₂O₃: 7.00 mol %, and ZnO: 3.00 mol % was used as the first glass powder.

### Example 4

A conductive aluminum paste composition was obtained in the same manner as in Example 1 except that lead-containing glass powder (P4) consisting of PbO: 60.00 mol %, SiO₂: 14.00 mol %, B₂O₃: 22.00 mol %, and Al₂O₃: 4.00 mol % was used as the first glass powder.

### Example 5

A conductive aluminum paste composition was obtained in the same manner as in Example 1 except that lead-containing glass powder (P5) consisting of PbO: 63.00 mol %, SiO₂: 8.00 mol %, B₂O₃: 22.00 mol %, Al₂O₃: 3.00 mol %, and ZnO: 4.00 mol % was used as the first glass powder.

### Example 6

A conductive aluminum paste composition was obtained in the same manner as in Example 1 except that lead-containing glass powder (P6) consisting of PbO: 66.00 mol %, SiO₂: 1.00 mol %, B₂O₃: 32.00 mol %, and Al₂O₃: 1.00 mol % was used as the first glass powder.

### Example 7

A conductive aluminum paste composition was obtained in the same manner as in Example 1 except that a lead-containing glass powder (P7) consisting of PbO: 71.00 mol %, SiO₂: 16.00 mol %, and B₂O₃: 13.00 mol % was used as the first glass powder, and a borosilicate glass powder (B2) consisting of B₂O₃: 43.70 mol %, SiO₂: 7.10 mol %, CaO: 18.00 mol %, BaO: 15.10 mol %, Sr: 4.70 mol %, and K₂O: 11.40 mol % was used as the second glass powder.

### Example 8

A conductive aluminum paste composition was obtained in the same manner as in Example 1 except that a borosilicate glass powder (B3) consisting of B₂O₃: 52.60 mol %, SiO₂: 8.70 mol %, CaO: 6.40 mol %, BaO: 18.40 mol %, and K₂O: 13.90 mol % was used as the second glass powder.

### Example 9

A conductive aluminum paste composition was obtained in the same manner as in Example 5 except that a borosilicate glass powder (B4) consisting of B₂O₃: 41.20 mol %, SiO₂: 6.90 mol %, CaO: 17.30 mol %, BaO: 14.50 mol %, and K₂O: 20.10 mol % was used as the second glass powder.

### Example 10

A conductive aluminum paste composition was obtained in the same manner as in Example 3 except that an aluminum-silicon alloy powder that was produced by a gas atomization method and had a D50 of 6.0 μm and a silicon concentration of 30 mass % was used.

### Example 11

A conductive aluminum paste composition was obtained in the same manner as in Example 3 except that an aluminum-silicon alloy powder that was produced by a gas atomization method and had a D50 of 6.0 μm and a silicon concentration of 40 mass % was used.

### Comparative Example 1

A conductive aluminum paste composition was obtained in the same manner as in Example 1 except that an aluminum powder (silicon concentration: 0 mass %) having a D50 of 6.0 μm and produced by a gas atomization method was used.

### Comparative Example 2

A conductive aluminum paste composition was obtained in the same manner as in Example 1 except that an aluminum-silicon alloy powder that was produced by a gas atomization method and had a D50 of 6.0 μm and a silicon concentration of 25 mass % was used.

### Comparative Example 3

A conductive aluminum paste composition was obtained in the same manner as in Example 1 except that lead-containing glass powder (P8) consisting of PbO: 13.00 mol %, SiC₂: 5.00 mol %, B₂O₃: 28.00 mole, and ZnO: 54.00 mol % was used as the first glass powder.

### Comparative Example 4

A conductive aluminum paste composition was obtained in the same manner as in Example 1 except that lead-containing glass powder (P9) consisting of PbO: 34.00 mol %, SiO₂: 57.00 mol %, B₂O₃: 5.00 mol %, Al₂O₃: 2.00 mol %, and ZnO: 2.00 mol % was used as the first glass powder.

### Comparative Example 5

A conductive aluminum paste composition was obtained in the same manner as in Example 8 except that a lead-containing glass powder (P10) consisting of PbO: 40.00 mol % and B₂O₃: 60.00 mol % was used as the first glass powder.

### Comparative Example 6

A conductive aluminum paste composition was obtained in the same manner as in Example 8 except that a lead-containing glass powder (P11) consisting of PbO: 47.00 mol %, SiO₂: 42.00 mol %, B₂O₃: 8.00 mol %, and Al₂O₃: 3.00 mol % was used as the first glass powder.

### Comparative Example 7

A conductive aluminum paste composition was obtained in the same manner as in Example 1 except that lead-containing glass powder (P12) consisting of PbO: 54.00 mol %, SiO₂: 15.00 mol %, B₂O₃: 4.00 mol %, Al₂O₃: 6.00 mol %, and ZnO: 21.00 mol % was used as the first glass powder.

### Comparative Example 8

A conductive aluminum paste composition was obtained in the same manner as in Example 1 except that a lead-containing glass powder (P13) consisting of PbO: 74.00 mol %, SiO₂: 16.00 mol %, and B₂O₃: 10.00 mol % was used as the first glass powder.

### Comparative Example 9

A conductive aluminum paste composition was obtained in the same manner as in Example 8 except that a lead-containing glass powder (P14) consisting of PbO: 76.00 mol %, SiO₂: 16.00 mol %, B₂O₃: 4.00 mol %, and Al₂O₃: 4.00 mol % was used as the first glass powder.

### Comparative Example 10

A conductive aluminum paste composition was obtained in the same manner as in Example 8 except that a lead-containing glass powder (P15) consisting of PbO: 80.00 mol % and B₂O₃: 20.00 mol % was used as the first glass powder.

### Comparative Example 11

A conductive aluminum paste composition was obtained in the same manner as in Example 1 except that borosilicate glass powder (B5) consisting of B₂O₃: 52.10 mol %, SiO₂: 8.50 mol %, CaO: 21.50 mol %, and BaO: 17.90 mol % was used as the second glass powder.

### Comparative Example 12

A conductive aluminum paste composition was obtained in the same manner as in Example 1 except that a borosilicate glass powder (B6) consisting of B₂O₃: 47.40 mol %, SiO₂: 7.70 mol %, CaO: 19.50 mol %, BaO: 16.30 mol %, and PbO: 9.10 mol % was used as the second glass powder.

### Comparative Example 13

A conductive aluminum paste composition was obtained in the same manner as in Example 1 except that borosilicate glass powder (B7) consisting of B₂O₃: 22.10 mol %, SiO₂: 8.60 mol %, CaO: 11.40 mol %, BaO: 19.60 mol %, K₂O: 6.70 mol %, and ZnO: 31.60 mol % was used as the second glass powder.

### Comparative Example 14

A conductive aluminum paste composition was obtained in the same manner as in Example 1 except that a borosilicate glass powder (B8) consisting of B₂O₃: 55.20 mol %, SiO₂: 8.80 mol %, CaO: 5.30 mol %, BaO: 15.90 mol %, K₂O: 9.00 mol %, and ZnO: 5.80 mole was used as the second glass powder.

### Comparative Example 15

A conductive aluminum paste composition was obtained in the same manner as in Example 1 except that a borosilicate glass powder (B9) consisting of B₂O₃: 54.10 mol %, SiO₂: 4.50 mol %, CaO: 6.00 mol %, BaO: 18.40 mol %, SrO: 4.80 mol %, K₂O: 5.50 mol %, and ZnO: 6.70 mol % was used as the second glass powder.

### Comparative Example 16

A conductive aluminum paste composition was obtained in the same manner as in Example 1 except that a borosilicate glass powder (B10) consisting of B₂O₃: 38.90 mol %, SiO₂: 30.70 mol %, CaO: 6.40 mol %, BaO: 12.80 mol %, and K₂O: 11.20 mol % was used as the second glass powder.

### Comparative Example 17

A conductive aluminum paste composition was obtained in the same manner as in Example 1 except that a borosilicate glass powder (B11) consisting of B₂O₃: 45.50 mol %, SiO₂: 8.90 mol %, CaO: 20.00 mol³, BaO: 0.40 mol %, SrO: 4.20 mol %, K₂O: 14.50 mol %, and ZnO: 6.50 mol % was used as the second glass powder.

### Comparative Example 18

A conductive aluminum paste composition was obtained in the same manner as in Example 1 except that a borosilicate glass powder (B12) consisting of B₂O₃: 43.40 mol %, SiO₂: 8.70 mol %, CaO: 7.90 mol %, BaO: 30.00 mol %, and K₂O: 10.00 mol % was used as the second glass powder.

### Comparative Example 19

A conductive aluminum paste composition was obtained in the same manner as in Example 1 except that a borosilicate glass powder (B13) consisting of B₂O₃: 45.50 mol %, SiO₂: 9.90 mol %, BaO: 18.40 mol %, and K₂O: 26.20 mol % was used as the second glass powder.

### Comparative Example 20

A conductive aluminum paste composition was obtained in the same manner as in Example 1 except that a borosilicate glass powder (B14) consisting of B₂O₃: 32.00 mol %, SiO₂: 7.60 mol %, CaO: 35.10 mol %, BaO: 10.00 mol %, SrO: 3.30 mol %, K₂O: 2.00 mol %, and ZnO: 10.00 mol % was used as the second glass powder.

### Comparative Example 21

A conductive aluminum paste composition was obtained in the same manner as in Example 1 except that a borosilicate glass powder (B15) consisting of B₂O₃: 39.50 mol %, SiO₂: 7.60 mol %, CaO: 5.50 mol %, BaO: 9.80 mol %, K₂O: 35.60 mol %, and ZnO: 2.09 mol % was used as the second glass powder.

### Example 12

A conductive aluminum paste composition was obtained in the same manner as in Example 4 except that a borosilicate glass powder (B16) having a second glass powder consisting of B₂O₃: 36.00 mol %, SiO₂: 10.00 mol %, CaO: 19.00 mol %, BaO: 15.00 mol %, and K₂O: 20.00 mol % was used.

### Example 13

A conductive aluminum paste composition was obtained in the same manner as in Example 4 except that a borosilicate glass powder (B18) having a second glass powder consisting of B₂O₃: 43.50 mol %, SiO₂: 7.10 mol %, CaO: 23.00 mol %, BaO: 15.00 mol %, and K₂O: 11.40 mol % was used.

### Example 14

A conductive aluminum paste composition was obtained in the same manner as in Example 4 except that a borosilicate glass powder (B20) having a second glass powder consisting of B₂O₃: 48.50 mol %, SiO₂: 7.50 mol %, CaO: 18.90 mol %, BaO: 3.20 mol %, and K₂O: 21.90 mol % was used.

### Example 15

A conductive aluminum paste composition was obtained in the same manner as in Example 4 except that a borosilicate glass powder (B22) having a second glass powder consisting of B₂O₃: 43.70 mol %, SiO₂: 9.90 mol %, CaO: 9.00 mol %, BaO: 4.70 mol %, SrO: 5.30 mol %, K₂O: 3.10 mol %, and ZnO: 24.30 mol % was used.

### Example 16

A conductive aluminum paste composition was obtained in the same manner as in Example 4 except that a borosilicate glass powder (B23) having a second glass powder consisting of B₂O₃: 40.20 mol %, SiO₂: 9.50 mol %, CaO: 5.00 mol %, BaO: 5.80 mol %, SrO: 3.30 mol %, K₂O: 28.50 mol %, and ZnO: 7.70 mol % was used.

### Comparative Example 22

A conductive aluminum paste composition was obtained in the same manner as in Example 8 except that a lead-containing glass powder (P16) consisting of PbO: 45.00 mol %, SiO₂: 27.00 mol %, B₂O₃: 20.00 mol %, Al₂O₃: 2.00 mol %, and ZnO: 6.00 mol % was used as the first glass powder.

### Comparative Example 23

A conductive aluminum paste composition was obtained in the same manner as in Example 8 except that a lead-containing glass powder (P17) consisting of PbO: 45.00 mol %, SiO₂: 16.00 mol %, B₂O₃: 38.00 mol %, and Al₂O₃: 1.00 mol % was used as the first glass powder.

### Comparative Example 24

A conductive aluminum paste composition was obtained in the same manner as in Example 4 except that a borosilicate glass powder (B17) having a second glass powder consisting of B₂O₃: 40.00 mol %, SiO₂: 11.00 mol %, CaO: 15.00 mol %, BaO: 20.00 mol %, K₂O: 4.00 mol %, and ZnO: 10.00 mol % was used.

### Comparative Example 25

A conductive aluminum paste composition was obtained in the same manner as in Example 4 except that a borosilicate glass powder (B19) having a second glass powder consisting of B₂O₃: 36.10 mol %, SiO₂: 8.70 mol %, CaO: 27.10 mol %, BaO: 8.90 mol %, K₂O: 9.80 mol %, and ZnO: 9.40 mol % was used.

### Comparative Example 26

A conductive aluminum paste composition was obtained in the same manner as in Example 4 except that a borosilicate glass powder (B21) having a second glass powder consisting of B₂O₃: 38.70 mol %, SiO₂: 9.70 mol %, CaO: 8.80 mol %, BaO: 22.20 mol %, K₂O: 9.50 mol %, and ZnO: 11.10 mol % was used.

### Preparation of Fired Substrate for Evaluation of Contact Resistance

As shown in FIGS. 1 and 2, a wafer was prepared in which an oxide (silicon oxide) layer 3 having a thickness of 5 nm, a microcrystalline n⁺ silicon layer 4 having a thickness of 200 nm, and a passivation film 5 were layered in this order from the inside on the surface opposite to the surface provided with the p-type impurity layer 2 on the n-type silicon semiconductor substrate 1. On the back surface of this wafer, the conductive aluminum paste compositions prepared in Examples and Comparative examples were screen-printed under the conditions that the thickness after printing was 20 to 30 μm, the width was 1 mm, the length was 10 mm, and the printing interval was 1.2 mm, 1.4 mm, 1.6 mm, 1.8 mm, and 2.0 mm in parallel. Next, the layered body after printing was placed in an infrared belt furnace set at 700° C. and fired at this temperature to form back-side electrodes 6. Thus, a fired substrate for evaluation was produced.

### Measurement and Evaluation of Contact Resistance

The electrical resistance of the obtained fired substrate for evaluation was measured using a resistance measuring instrument (product name: mΩ HiTESTER 3540) manufactured by HIOKI E.E. CORPORATION, and the contact resistance between back-side electrodes 6 and the microcrystalline n⁺ silicon layer 4 was calculated by a transmission line method (TLM). The contact resistance with which a good ohmic contact can be obtained is 10 mΩ·cm² or less.

### Preparation of Solar Cell

On the back surface of the wafer, the conductive aluminum paste composition prepared in each of Examples and Comparative examples was printed in a comb pattern so as to be 0.2 to 0.3 g/l cell, then a silver paste for finger electrodes formation was printed on the light receiving surface of the wafer, and back-side electrodes and finger electrodes were formed using an infrared belt furnace set at 800° C. Thus, a solar cell was produced.

Evaluation of Presence or Absence of Penetration of Passivation Film and Erosion on Microcrystalline n⁺ Silicon Layer 4

Back-side electrodes 6 formed in the solar cell was removed by immersing back-side electrodes 6 in an aqueous hydrochloric acid solution at room temperature for 60 minutes, and then observed with an optical microscope to confirm the presence or absence of penetration of the passivation film 5. A film penetrating (fire-through) the passivation film 5 was evaluated as “A”, and a film not penetrating the passivation film 5 was evaluated as “B”. The film penetrating the passivation film 5 was observed with a scanning electron microscope (SEM) to confirm the presence or absence of erosion of the microcrystalline n⁺ silicon layer 4. The microcrystalline n⁺ silicon layer 4 that was not eroded was evaluated as “A”, and the microcrystalline n⁺ silicon layer 4 that was eroded was evaluated as “B”. The film that did not penetrate the passivation film 5 was described as “−” because the presence or absence of erosion of the microcrystalline n⁺ silicon layer 4 could not be confirmed.

The above results are shown in Table 1.

TABLE 1

| | | | First glass powder | | | | | | | | Second glass powder | |
|---|---|---|---|---|---|---|---|---|---|---|---|---|
| | | | Glass | | | | | | | | Glass | |
| | [symbol] | | abbre- | | | | | | | | abbre- | |
| | powder | | viation | | | | | | | | viation | |
| | Al | Si | (Abbre- | PbO | SO [symbol] | B [symbol] O [symbol] | AlO [symbol] | Z [symbol] O | | (B [symbol] O [symbol] + SO [symbol] )/ | (Abbre- | B [symbol] O [symbol] |
| | (wt %) | (wt %) | viation) | mol % | mol % | mol % | mol % | mol % | Total | PbO | viation) | mol % |
| Example 1 | [symbol] 4 | 3 [symbol] | P1 | 50.00 | 23.00 | 20.00 | 7.00 | | 100.00 | 0.8 [symbol] | B1 | 45.50 |
| Example 2 | [symbol] 4 | 3 [symbol] | P2 | 54.40 | 12. [symbol] 0 | 23.50 | 5.70 | 3. [symbol] 0 | 100.00 | 0.67 | B1 | 45.50 |
| Example 3 | [symbol] 4 | 3 [symbol] | P3 | 45.00 | 15.00 | 30.00 | 7.00 | 3.00 | 100.00 | 1.00 | B1 | 45.50 |
| Example 4 | [symbol] 4 | 3 [symbol] | P4 | 60.00 | 14.00 | 22.00 | 4.00 | | 100.00 | 0.60 | B1 | 45.50 |
| Example 5 | [symbol] 4 | 3 [symbol] | P5 | 63.00 | 8.00 | 22.00 | 3.00 | 4.00 | 100.00 | 0.48 | B1 | 45.50 |
| Example 6 | [symbol] 4 | 3 [symbol] | P6 | 66.00 | 1.00 | 32.00 | 1.00 | | 100.00 | 0.50 | B1 | 45.50 |
| Example 7 | [symbol] 4 | 3 [symbol] | P7 | 71.00 | 1 [symbol] .00 | 13.00 | | | 100.00 | 0.41 | B2 | 43.70 |
| Example 8 | [symbol] 4 | 3 [symbol] | P1 | 50.00 | 23.00 | 20.00 | 7.00 | | 100.00 | 0.8 [symbol] | B3 | 52. [symbol] 0 |
| Example 9 | [symbol] 4 | 3 [symbol] | P5 | 63.00 | 8.00 | 22.00 | 3.00 | 4.00 | 100.00 | 0.48 | B4 | 41.20 |
| Example 10 | 70 | 30 | P3 | 45.00 | 15.00 | 30.00 | 7.00 | 3.00 | 100.00 | 1.00 | B1 | 4 [symbol] .50 |
| Example 11 | [symbol] 0 | 40 | P3 | 45.00 | 15.00 | 30.00 | 7.00 | 3.00 | 100.00 | 1.00 | B1 | 4 [symbol] .50 |
| Comparative | 100 | 0 | P1 | 50.00 | 23.00 | 20.00 | 7.00 | | 100.00 | 0.86 | B1 | 4 [symbol] .50 |
| Example 1 | | | | | | | | | | | | |
| Comparative | 75 | 25 | P1 | 50.00 | 23.00 | [symbol] 0.00 | 7.00 | | 100.00 | 0. [symbol] | B1 | 4 [symbol] .50 |
| Example 2 | | | | | | | | | | | | |
| Comparative | [symbol] 4 | 3 [symbol] | P8 | 13.00 | 5.00 | 28.00 | | 54.00 | 100.00 | 2.54 | B1 | 4 [symbol] .50 |
| Example 3 | | | | | | | | | | | | |
| Comparative | [symbol] 4 | 3 [symbol] | P9 | 34.00 | 57.00 | [symbol] .00 | 2.00 | 2.00 | 100.00 | 1.82 | B1 | 4 [symbol] .50 |
| Example 4 | | | | | | | | | | | | |
| Comparative | [symbol] 4 | 3 [symbol] | P10 | 40.00 | | [symbol] 0.00 | | | 100.00 | 1.50 | B3 | 52.60 |
| Example 5 | | | | | | | | | | | | |
| Comparative | [symbol] 4 | 3 [symbol] | P11 | 47.00 | 42.00 | 8.00 | 3.00 | | 100.00 | 1.06 | B3 | 52.60 |
| Example 6 | | | | | | | | | | | | |
| Comparative | [symbol] 4 | 3 [symbol] | P12 | 54.00 | 15.00 | 4.00 | [symbol] .00 | 21.00 | 100.00 | 0.3 [symbol] | B1 | 45.50 |
| Example 7 | | | | | | | | | | | | |
| Comparative | [symbol] 4 | 3 [symbol] | P13 | 74.00 | 1 [symbol] .00 | 10.00 | | | 100.00 | 0.35 | B1 | 45.50 |
| Example 8 | | | | | | | | | | | | |
| Comparative | [symbol] 4 | 3 [symbol] | P14 | 76.00 | 1 [symbol] .00 | 4.00 | 4.00 | | 100.00 | 0.28 | B3 | 52.60 |
| Example 9 | | | | | | | | | | | | |
| Comparative | [symbol] 4 | 3 [symbol] | P15 | 80.00 | | 20.00 | | | 100.00 | 0.25 | B3 | 52.60 |
| Example 10 | | | | | | | | | | | | |
| Comparative | [symbol] 4 | 3 [symbol] | P1 | 50.00 | 23.00 | 20.00 | 7.00 | | 100.00 | 0.86 | B [symbol] | 52.10 |
| Example 11 | | | | | | | | | | | | |
| Comparative | [symbol] 4 | 3 [symbol] | P1 | 50.00 | 23.00 | 20.00 | 7.00 | | 100.00 | 0.86 | B6 | 47.40 |
| Example 12 | | | | | | | | | | | | |
| Comparative | [symbol] 4 | 3 [symbol] | P1 | 50.00 | 23.00 | 20.00 | 7.00 | | 100.00 | 0.8 [symbol] | B7 | 22.10 |
| Example 13 | | | | | | | | | | | | |
| Comparative | [symbol] 4 | 3 [symbol] | P1 | 50.00 | 23.00 | 20.00 | 7.00 | | 100.00 | 0.8 [symbol] | B8 | 5 [symbol] . [symbol] 0 |
| Example 14 | | | | | | | | | | | | |
| Comparative | [symbol] 4 | 3 [symbol] | P1 | 50.00 | 23.00 | 20.00 | 7.00 | | 100.00 | 0.86 | B9 | 54.10 |
| Example 15 | | | | | | | | | | | | |
| Comparative | [symbol] 4 | 3 [symbol] | P1 | 50.00 | 23.00 | 20.00 | 7.00 | | 100.00 | 0.86 | B10 | 3 [symbol] .90 |
| Example 16 | | | | | | | | | | | | |
| Comparative | [symbol] 4 | 3 [symbol] | P1 | 50.00 | 23.00 | 20.00 | 7.00 | | 100.00 | 0.86 | B11 | 45.50 |
| Example 17 | | | | | | | | | | | | |
| Comparative | [symbol] 4 | 3 [symbol] | P1 | 50.00 | 23.00 | 20.00 | 7.00 | | 100.00 | 0.8 [symbol] | B12 | 43. [symbol] 0 |
| Example 18 | | | | | | | | | | | | |
| Comparative | [symbol] 4 | 3 [symbol] | P1 | 50.00 | 23.00 | 20.00 | 7.00 | | 100.00 | 0.8 [symbol] | B13 | 4 [symbol] . [symbol] 0 |
| Example 19 | | | | | | | | | | | | |
| Comparative | [symbol] 4 | 3 [symbol] | P1 | 50.00 | 23.00 | 20.00 | 7.00 | | 100.00 | 0.86 | B14 | 32.00 |
| Example 20 | | | | | | | | | | | | |
| Comparative | [symbol] 4 | 3 [symbol] | P1 | 50.00 | 23.00 | [symbol] 0.00 | 7.00 | | 100.00 | 0.86 | B15 | 39.50 |
| Example 21 | | | | | | | | | | | | |
| Comparative | [symbol] 4 | 3 [symbol] | P16 | 45.00 | 27.00 | 20.00 | 2.00 | 6.00 | 100.00 | 1.04 | B3 | 52.60 |
| Example 22 | | | | | | | | | | | | |
| Comparative | [symbol] 4 | 3 [symbol] | P17 | 45.00 | 1 [symbol] .00 | 3 [symbol] .00 | 1.00 | | 100.00 | 1.20 | B3 | 52.60 |
| Example 23 | | | | | | | | | | | | |
| Example 12 | [symbol] 4 | 3 [symbol] | P4 | [symbol] 0.00 | 14.00 | 22.00 | 4.00 | | 100.00 | 0. [symbol] 0 | B16 | 3 [symbol] .00 |
| Comparative | [symbol] 4 | 3 [symbol] | P4 | [symbol] 0.00 | 14.00 | 22.00 | 4.00 | | 100.00 | 0. [symbol] 0 | B17 | 40.00 |
| Example 24 | | | | | | | | | | | | |
| Example 13 | [symbol] 4 | 3 [symbol] | P4 | [symbol] 0.00 | 14.00 | 22.00 | 4.00 | | 100.00 | 0. [symbol] 0 | B18 | 43.50 |
| Comparative | [symbol] 4 | 3 [symbol] | P4 | [symbol] 0.00 | 14.00 | 22.00 | 4.00 | | 100.00 | 0. [symbol] 0 | B19 | 36.10 |
| Example 25 | | | | | | | | | | | | |
| Example 14 | [symbol] 4 | 3 [symbol] | P4 | [symbol] 0.00 | 14.00 | 22.00 | 4.00 | | 100.00 | 0. [symbol] 0 | B20 | 48.50 |
| Comparative | [symbol] 4 | 3 [symbol] | P4 | [symbol] 0.00 | 14.00 | 22.00 | 4.00 | | 100.00 | 0. [symbol] 0 | B21 | 38.70 |
| Example 26 | | | | | | | | | | | | |
| Example 15 | [symbol] 4 | 3 [symbol] | P4 | [symbol] 0.00 | 14.00 | 22.00 | 4.00 | | 100.00 | 0. [symbol] 0 | B22 | 43.70 |
| Example 16 | [symbol] 4 | 3 [symbol] | P4 | [symbol] 0.00 | 14.00 | 22.00 | 4.00 | | 100.00 | 0. [symbol] 0 | B23 | 40.20 |

| | | | | | | | | | Results | | |
|---|---|---|---|---|---|---|---|---|---|---|---|
| | | | | | | | | | | [symbol] | |
| | Second glass powder | | | | | | | | [symbol] | absencent | |
| | SiO [symbol] | CaO | BaO | SiO | K [symbol] O | PbO | Z [symbol] O | | R [symbol] | penetration of | |
| | mol % | mol % | mol % | mol % | mol % | mol % | mol % | Total | (mΩ · cm [symbol] ) | [symbol] | [symbol] |
| Example 1 | 7. [symbol] 0 | 19.00 | 15. [symbol] 0 | | 12.00 | | | 100.0 | 5.8 | A | A |
| Example 2 | 7. [symbol] 0 | 19.00 | 15. [symbol] 0 | | 12.00 | | | 100.0 | 7.5 | A | A |
| Example 3 | 7. [symbol] 0 | 19.00 | 15. [symbol] 0 | | 12.00 | | | 100.0 | 6.0 | A | A |
| Example 4 | 7. [symbol] 0 | 19.00 | 15. [symbol] 0 | | 12.00 | | | 100.0 | 7.1 | A | A |
| Example 5 | 7. [symbol] 0 | 19.00 | 15. [symbol] 0 | | 12.00 | | | 100.0 | 5.8 | A | A |
| Example 6 | 7. [symbol] 0 | 19.00 | 15. [symbol] 0 | | 12.00 | | | 100.0 | 4.2 | A | A |
| Example 7 | 7.10 | 18.00 | 15.10 | 4.70 | 11.40 | | | 100.0 | 3.1 | A | A |
| Example 8 | 8.70 | [symbol] .40 | 18.40 | | 13. [symbol] 0 | | | 100.0 | 6.2 | A | A |
| Example 9 | 6.90 | 17.30 | 14.50 | | 20.10 | | | 100.0 | 4.7 | A | A |
| Example 10 | 7. [symbol] 0 | 19.00 | 15. [symbol] 0 | | 12.00 | | | 100.0 | 5.4 | A | A |
| Example 11 | 7. [symbol] 0 | 19.00 | 15. [symbol] 0 | | 12.00 | | | 100.0 | 9.6 | A | A |
| Comparative | 7. [symbol] 0 | 19.00 | 15.90 | | 12.00 | | | 100.0 | 2.5 | A | B |
| Example 1 | | | | | | | | | | | |
| Comparative | 7. [symbol] 0 | 1 [symbol] .00 | 15.90 | | 12.00 | | | 100.0 | 3.4 | A | B |
| Example 2 | | | | | | | | | | | |
| Comparative | 7. [symbol] 0 | 1 [symbol] .00 | 15.90 | | 12.00 | | | 100.0 | 201.0 | B | — |
| Example 3 | | | | | | | | | | | |
| Comparative | 7. [symbol] 0 | 19.00 | 15. [symbol] 0 | | 12.00 | | | 100.0 | 113.0 | B | — |
| Example 4 | | | | | | | | | | | |
| Comparative | 8.70 | 6.40 | 18.40 | | 13.90 | | | 100.0 | 50.7 | B | — |
| Example 5 | | | | | | | | | | | |
| Comparative | 8.70 | 6.40 | 18.40 | | 13.90 | | | 100.0 | [symbol] 8.1 | B | — |
| Example 6 | | | | | | | | | | | |
| Comparative | 7. [symbol] 0 | 1 [symbol] .00 | 15.90 | | 12.00 | | | 100.0 | 37.3 | A | A |
| Example 7 | | | | | | | | | | | |
| Comparative | 7. [symbol] 0 | 19.00 | 15. [symbol] 0 | | 12.00 | | | 100.0 | 4.2 | A | B |
| Example 8 | | | | | | | | | | | |
| Comparative | 8.70 | 6.40 | 18.40 | | 13. [symbol] 0 | | | 100.0 | 6.5 | A | B |
| Example 9 | | | | | | | | | | | |
| Comparative | 8.70 | 6.40 | 18.40 | | 13.90 | | | 100.0 | 10.7 | A | B |
| Example 10 | | | | | | | | | | | |
| Comparative | 8.50 | 21.50 | 17.90 | | 0.00 | | | 100.0 | [symbol] 6.0 | B | — |
| Example 11 | | | | | | | | | | | |
| Comparative | 7.70 | 19.50 | 1 [symbol] .30 | | 0.00 | 9.10 | | 100.0 | [symbol] 2.7 | B | — |
| Example 12 | | | | | | | | | | | |
| Comparative | 8. [symbol] 0 | 11.40 | 1 [symbol] . [symbol] 0 | | 6.70 | | 31. [symbol] 0 | 100.0 | 82.3 | B | — |
| Example 13 | | | | | | | | | | | |
| Comparative | 8.80 | 5.30 | 15. [symbol] 0 | | [symbol] .00 | | 5.80 | 100.0 | 51.3 | B | — |
| Example 14 | | | | | | | | | | | |
| Comparative | 4.50 | 6.00 | 18.40 | 4.80 | 5.50 | | 6.70 | 100.0 | 78.4 | B | — |
| Example 15 | | | | | | | | | | | |
| Comparative | 30.70 | 6.40 | 12. [symbol] 0 | | 11. [symbol] 0 | | | 100.0 | [symbol] .0 | B | — |
| Example 16 | | | | | | | | | | | |
| Comparative | 8.90 | 20.00 | 0.40 | 4.20 | 14.50 | | 6.50 | 100.0 | 1 [symbol] .00 | B | — |
| Example 17 | | | | | | | | | | | |
| Comparative | 8.70 | 7. [symbol] 0 | 30.00 | | 10.00 | | | 100.0 | 5 [symbol] .4 | B | — |
| Example 18 | | | | | | | | | | | |
| Comparative | [symbol] . [symbol] 0 | | 18.40 | | 2 [symbol] .20 | | | 100.0 | 88.0 | B | — |
| Example 19 | | | | | | | | | | | |
| Comparative | 7. [symbol] 0 | 3 [symbol] .10 | 10.00 | 3.30 | 2.00 | | 10.00 | 100.0 | [symbol] 0.9 | B | — |
| Example 20 | | | | | | | | | | | |
| Comparative | 7. [symbol] 0 | 5.50 | 9. [symbol] 0 | | 36. [symbol] 0 | | 2.00 | 100.0 | 51.2 | B | — |
| Example 21 | | | | | | | | | | | |
| Comparative | 8.70 | [symbol] .40 | 18.40 | | 13.90 | | | 100.0 | 138.9 | B | — |
| Example 22 | | | | | | | | | | | |
| Comparative | 8.70 | 6.40 | 18.40 | | 13.90 | | | 100.0 | 194.0 | B | — |
| Example 23 | | | | | | | | | | | |
| Example 12 | 10.00 | 19.00 | 15.00 | | 20.00 | | | 100.0 | 9.2 | A | A |
| Comparative | 11.00 | 15.00 | 20.00 | | 4.00 | | 10.00 | 100.0 | 124.5 | B | — |
| Example 24 | | | | | | | | | | | |
| Example 13 | 7.10 | 23.00 | 15.00 | | 11.40 | | | 100.0 | 8.8 | A | A |
| Comparative | 8.70 | 27.10 | 8. [symbol] 0 | | 9.80 | | [symbol] .40 | 100.0 | 14 [symbol] | B | — |
| Example 25 | | | | | | | | | | | |
| Example 14 | 7.50 | 18. [symbol] 0 | 3.20 | | 21.90 | | | 100.0 | 4.7 | A | A |
| Comparative | 9.70 | 8.80 | 22.20 | | 9.50 | | 11.10 | 100.0 | 1362 | B | — |
| Example 26 | | | | | | | | | | | |
| Example 15 | 9. [symbol] 0 | 9.00 | 4.70 | 5.30 | 3.10 | | 24.30 | 100.0 | 9.1 | A | A |
| Example 16 | 9. [symbol] 0 | 5.00 | 5.80 | 3.30 | 28.50 | | 7.70 | 100.0 | 3.9 | A | A |

[symbol]

indicates data missing or illegible when filed

As shown in Table 1, it was confirmed that by containing an aluminum-silicon alloy powder having a specific composition prescribed in the present invention and a glass powder, the paste itself had a fire-through property of a passivation film in formation of back-side electrodes of a TOPCon Si solar cell, and it was not necessary to form LCO, and further, a good ohmic contact could be obtained without forming an alloy layer with an n-type silicon substrate.

### DESCRIPTION OF REFERENCE NUMERALS

1 n-type silicon semiconductor substrate
2 p-type impurity layer
3 Oxide layer
4 Microcrystalline n⁺ silicon layer
5 Passivation film
6 Sintered body of conductive aluminum paste composition (back-side electrodes)

1. A conductive aluminum paste composition for TOPCon Si solar cell electrodes, the conductive aluminum paste composition comprising an aluminum-silicon alloy powder, an organic vehicle, and a glass powder,
wherein
(1) the aluminum-silicon alloy powder has a silicon concentration of 30 mass % or more and 40 mass % or less, and
(2) the glass powder contains a first glass powder and a second glass powder, and
the first glass powder contains 45% or more and 71% or less of PbO, 5% or more and 35% or less of B₂O₃, and 0.1% or more and 25.0% or less of SiO₂ in terms of oxide mol %, and a value of [(x+y)/z] is in a range of 0.40 or more and 1.00 or less where the content of B₂O₃ is x mol %, the content of SiO₂ is y mol %, and the content of PbO is z mol %, and
the second glass powder contains 35.0% or more and 55.0% or less of B₂O₃, 5.0% or more and 10.0% or less of SiO₂, 1.0% or more and 20.0% or less of BaO, 5.0% or more and 25.0% or less of CaO, and 3.0% or more and 30.0% or less of K₂O in terms of oxide mol %, and does not substantially contain PbO.

2. The conductive aluminum paste composition according to claim 1, wherein the first glass powder contains Al₂O₃ and/or ZnO in a total amount of 1% or more and 10% or less in terms of oxide mol %.

3. The conductive aluminum paste composition according to claim 1, wherein the second glass powder contains 1.0% or more and 10.0% or less of SrO in terms of oxide mol %.

4. A TOPCon Si solar cell, wherein back-side electrodes which are sintered body of the conductive aluminum paste composition according to claim 1 is layered on a silicon semiconductor substrate.

5. A TOPCon Si solar cell, wherein back-side electrodes which are sintered body of the conductive aluminum paste composition according to claim 2 is layered on a silicon semiconductor substrate.

6. A TOPCon Si solar cell, wherein back-side electrodes which are sintered body of the conductive aluminum paste composition according to claim 3 is layered on a silicon semiconductor substrate.
